(19) United States
(12) Patent Application Publication
(10) Pub. No.: US 2012/0054806 A1
(43) Pub. Date: Mar. 1, 2012

(54) METHODS CIRCUITS & SYSTEMS FOR WIRELESS VIDEO TRANSMISSION

(76) Inventors: Zvi REZNIC, Tel Aviv (IL); Shay Freundlich, Sunnyvalle, CA (US); Noam Geri, Los Altos, CA (US); Yoav Nissan-Cohen, Tel Aviv (IL); Ofer Peer, Herzliya (IL)

(21) Appl. No.: 13/219,935

(22) Filed: Aug. 29, 2011

Related U.S. Application Data
(60) Provisional application No. 61/377,919, filed on Aug. 28, 2010.

(51) Int. Cl. H04N 7/18

(52) U.S. Cl. 725/81

(57) ABSTRACT

Disclosed are methods, circuits & systems for transmitting a video stream over a wireless data link and devices implementing said methods, circuits & systems. A host device may include a video transmitter adapted to transmit a video stream via a shared radio-frequency (RF) transmitter. The video stream may be processed, encoded, edited and/or managed by one or more baseband processor(s) functionally associated with the RF transmitter before transmission. The video transmitter may include a video baseband processing logic (VBBPL) for processing video data and a data baseband processing logic (DBBPL) for processing a plurality of data types. The VBBPL may be adapted to encode raw (i.e. substantially uncompressed) video data and/or append control layer data (e.g. overlay video data) to encoded video.

### RELATED APPLICATIONS

The present application claims priority from: (1) U.S. Provisional Patent Application Ser. No. 61/377,919, filed on Aug. 28, 2010; and (2) U.S. Utility patent application Ser. No. 13/067,891, filed on Jul. 5, 2011, both of which are hereby incorporated by reference in their entirety.

### FIELD OF THE INVENTION

Some embodiments relate generally to the field of communication and, more particularly, to methods, circuits & systems for transmitting a video stream over a wireless data link and devices implementing said methods, circuits & systems.

### BACKGROUND

Wireless communication has rapidly evolved over the past decades. Even today, when high performance and high bandwidth wireless communication equipment is made available there is demand for even higher performance at a higher data rates, which may be required by more demanding applications.

A video stream may be generated or received by various mobile computing or communications devices, for example, a laptop computer, a netbook, a tablet computer, a smart phone, a game console, an e-book reader, or any other suitable mobile computing or communications device. In many devices, for example, a video stream is generated by the device to view on an integral viewing screen, store or transmit to a functionally associated device. A video stream may be received from a functionally associated device, an internal or external memory, a data server, a streaming application, a removable media storage device or any other suitable media storage.

In many cases, the integral viewing screen may be too small and/or may be of poor quality for certain applications (e.g. high definition movie viewing). It may be desired to place a screen or projector at a location in a distance of at least a few meters from the video source. This trend is becoming more common as flat-screen displays, e.g., plasma or Liquid Crystal Display (LCD) televisions are hung on a wall. Connection of such a display or projector to the video source through cables is generally undesired for aesthetic reasons and/or installation convenience. Thus, wireless transmission of the video signals from the video source to the screen is preferred.

WHDI—Wireless Home Digital Interface is a standard for wireless high-definition video connectivity between a video source and video sink (e.g. display). It provides a high-quality, uncompressed wireless link which can support delivery of equivalent video data rates of up to 3 Gbit/s (including uncompressed 1080 p) in a 40 MHz channel within the 5 GHz unlicensed band. Equivalent video data rates of up to 1.5 Gbit/s (including uncompressed 1080 i and 720 p) can be delivered on a single 20 MHz channel in the 5 GHz unlicensed band, conforming to worldwide 5 GHz spectrum regulations. Range is beyond 100 feet (30 m), through walls, and latency is less than one millisecond.

For integration with computing or communications devices, WHDI technology may be adapted for available computing power and for an integral radio-frequency (RF) transmitter. It may be beneficial to share an integral RF transmitter between multiple data transmission methods, including encoded and/or compressed video transmission (e.g. Wi-Fi Direct or Wi-Fi Display) in addition to control layer data and/or data network based data transmission.

There is thus a need in the field of wireless communication for improved methods, circuits & systems for transmitting a video stream over a wireless data link and devices implementing said methods, circuits & systems.

### SUMMARY

The present invention includes methods, circuits & systems for transmitting a video stream over a wireless data link and devices implementing said methods, circuits & systems. According to some embodiments of the present invention, a host device may include a video transmitter adapted to transmit a video stream via a shared radio-frequency (RF) transmitter. The video stream may be processed, encoded, edited and/or managed by one or more baseband processor(s) functionally associated with the RF transmitter before transmission. According to further embodiments of the present invention, the video transmitter may include a video baseband processing logic (VBBPL) for processing video data and a data baseband processing logic (DBBPL) for processing a plurality of data types. The VBBPL may be adapted to encode raw (i.e. substantially uncompressed) video data and/or append control layer data (e.g. overlay video data) to encoded video.

According to some embodiments of the present invention, the VBBPL may be connected to a graphics processing unit (GPU) of the host device. According to some embodiments of the present invention, the VBBPL may be connected to an application processor of the host device via a video bus. According to some embodiments of the present invention, the DBBPL may be connected to a host device data bus. The DBBPL may receive encoded video, e.g. MPEG-4 and/or MPEG-4 advance video coding (MPEG-4AVC-H.264) and/or control layer overlay instructions from the data bus.

According to some embodiments of the present invention, the VBBPL and DBBPL may be interconnected via an internal bus or a point-to-point connection, e.g. secure digital input output (SDIO). The VBBPL and DBBPL may be connected to a shared buffer (e.g. a transmission buffer feeding into a packetizer/framer).

According to some embodiments of the present invention, the VBBPL and DBBPL may be connected to a shared RF transmitter with a digital connection. The digital connection may be a SDIO connection. The digital connection may be via a shared buffer (e.g. a transmission buffer feeding into a packetizer/framer). According to some embodiments of the present invention, the VBBPL and DBBPL may be connected to a shared RF transmitter with an analog connection. The analog connection may include transmitting complex analog data (i.e. Amplitude/Phase or I/Q data) from one of the BBPLs to another.

According to some embodiments of the present invention, the VBBPL may manage wireless video transmission sessions utilizing uncompressed video transmission architecture (e.g. WHDI). According to further embodiments of the present invention, the VBBPL may manage wireless video transmission sessions utilizing an encoded (i.e. compressed) video transmission architecture (e.g. Wi-Fi direct and/or Wi-Fi display). According to some embodiments of the present invention, the VBBPL may include a video encoder for encoding raw (i.e. substantially uncompressed) video data (e.g. received through the video bus) into an encoded (i.e. compressed) video transmission format (e.g. H.264 scalable and/or multi-view encoding). The video encoder may be adaptable and/or selectable for encoding video in a format suitable for a target display and/or video sink.

According to some embodiments of the present invention, the VBBPL may include an encoded video editor (e.g. an H.264 editor) for editing and/or appending data, such as control layer data, to encoded video data. According to further embodiments of the present invention, editing encoded video data may include appending received control layer data to a received encoded video data segment, wherein the control layer data may include user interface related images, icons or controls generated or otherwise provided by a controller of a device functionally associated with the transmitter.

According to some embodiments of the present invention, the DBBPL may process, manage and/or condition data bits in accordance with wireless network data transmission protocols, schemes or architectures such as Wi-Fi. According to further embodiments of the present invention, encoded video data received by the DBBPL via a data bus of a host device may be forwarded or delivered to the VBBPL. Video data delivered to the VBBPL may be processed by the video encoder (e.g. for encoding into a video format suitable for a target display and/or video sink) and/or the encoded video editor (e.g. for appending received control layer data). According to further embodiments, encoded video data received at the DBBPL through the data bus may pass through a buffer shared with the one or more components of the VBBPL. The encoded video editor, whether it is part of a VBBPL or discrete, may have access to the buffer and may be adapted to edit encoded video data within the buffer.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a diagram illustrating an exemplary arrangement of video transmitting host devices and a video receiving display, according to embodiments of the present invention;

FIG. 2A is a functional block diagram of a video transmitter according to embodiments of the present invention, where a radio-frequency integrated circuit (RFIC) is shared between a video baseband processing logic (VBBPL) and a data baseband processing logic (DBBPL). In this exemplary embodiment, the VBBPL and DBBPL are located on the same baseband IC;

FIG. 2B is a functional block diagram of a video transmitter card (e.g. display minicard) according to embodiments of the present invention where radio-frequency (RF) circuitry is shared between a video baseband processing logic (VBBPL) and a data baseband processing logic (DBBPL);

FIG. 2C is a functional block diagram of an optical disk reader and video transmitter according to embodiments of the present invention where a DBBPL may include an encoded video editor for appending control layer data to encoded video data;

FIG. 3 is a functional block diagram of a video transmitter for a host device, according to embodiments of the present invention where the VBBPL and DBBPL share a buffer and packetizer in addition to an RFIC;

FIG. 4 is a flowchart including the steps of an exemplary method by which the video transmitter of FIG. 3 may operate, in accordance with some embodiments of the present invention;

FIGS. 5A & 5B are block diagrams of exemplary configurations for the integration of a video baseband (e.g. Wireless High Definition Interface—WHDI, Wi-Fi direct or Wi-Fi display) IC into an exemplary computing and/or communications device as a companion IC, in accordance with some embodiments of the present invention;

FIGS. 6A & 6B are block diagrams of exemplary configurations for the integration of a video baseband (e.g. Wireless High Definition Interface—WHDI, Wi-Fi direct or Wi-Fi display) IC into a connectivity chip (e.g. Wi-Fi IC) of an exemplary computing and/or communications device, in accordance with some embodiments of the present invention; and

FIGS. 7A-7C are block diagrams of exemplary configurations for the integration of a video baseband (e.g. Wireless High Definition Interface—WHDI, Wi-Fi direct or Wi-Fi display) IC into an Application Processor of an exemplary computing and/or communications device, in accordance with some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices. In addition, the term “plurality” may be used throughout the specification to describe two or more components, devices, elements, parameters and the like.

It should be understood that some embodiments may be used in a variety of applications. Although embodiments of the invention are not limited in this respect, one or more of the methods, devices and/or systems disclosed herein may be used in many applications, e.g., civil applications, military applications, medical applications, commercial applications, or any other suitable application. In some demonstrative embodiments the methods, devices and/or systems disclosed herein may be used in the field of consumer electronics, for example, as part of any suitable television, video Accessories, Digital-Versatile-Disc (DVD), multimedia projectors, Audio and/or Video (A/V) receivers/transmitters, gaming consoles, video cameras, video recorders, portable media players, cell phones, mobile devices, and/or automobile A/V accessories. In some demonstrative embodiments the methods, devices and/or systems disclosed herein may be used in the field of Personal Computers (PC), for example, as part of any suitable desktop PC, notebook PC, monitor, and/or PC accessories. In some demonstrative embodiments the methods, devices and/or systems disclosed herein may be used in the field of professional A/V, for example, as part of any suitable camera, video camera, and/or A/V accessories. In some demonstrative embodiments the methods, devices and/or systems disclosed herein may be used in the medical field, for example, as part of any suitable endoscopy device and/or system, medical video monitor, and/or medical accessories. In some demonstrative embodiments the methods, devices and/or systems disclosed herein may be used in the field of security and/or surveillance, for example, as part of any suitable security camera, and/or surveillance equipment. In some demonstrative embodiments the methods, devices and/or systems disclosed herein may be used in the fields of military, defense, digital signage, commercial displays, retail accessories, and/or any other suitable field or application.

Although embodiments of the invention are not limited in this respect, one or more of the methods, devices and/or systems disclosed herein may be used to wirelessly transmit video signals, for example, High-Definition-Television (HDTV) signals, between at least one video source and at least one video destination. In other embodiments, the methods, devices and/or systems disclosed herein may be used to transmit, in addition to or instead of the video signals, any other suitable signals, for example, any suitable multimedia signals, e.g., audio signals, between any suitable multimedia source and/or destination.

Although some demonstrative embodiments are described herein with relation to wireless communication including video information, some embodiments may be implemented to perform wireless communication of any other suitable information, for example, multimedia information, e.g., audio information, in addition to or instead of the video information. Some embodiments may include, for example, a method, device and/or system of performing wireless communication of A/V information, e.g., including audio and/or video information. Accordingly, one or more of the devices, systems and/or methods described herein with relation to video information may be adapted to perform wireless communication of A/V information.

Some demonstrative embodiments may be implemented to communicate wireless-video signals over a wireless-video communication link, as well as Wireless-Local-Area-Network (WLAN) signals over a WLAN link. Such implementation may allow a user, for example, to play a movie, e.g., on a laptop computer, and to wirelessly transmit video signals corresponding to the movie to a video destination, e.g., a screen, while maintaining a WLAN connection, e.g., with the Internet and/or one or more other devices connected to a WLAN network. In one example, video information corresponding to the movie may be received over the WLAN network, e.g., from the Internet.

According to some embodiments of the present invention, there may include a video circuit comprising: video baseband processing logic (VBBPL) adapted to manage video specific wireless communication sessions; data baseband processing logic (DBBPL) adapted to manage data specific wireless communication sessions; and a radio-frequency (RF) transmission chain (TX) functionally associated with the VBBPL and with the DBBPL, and adapted to generate wireless transmission signals corresponding to outputs of the VBBPL and the DBBPL. The outputs of the VBBPL and the DBBPL may be interleaved.

According to some embodiments of the present invention, the VBBPL may further comprise a video encoding logic to encode raw video data. According to some embodiments of the present invention, the video encoding logic may be Wireless High Definition Interface (WHDI) compliant. According to some embodiments of the present invention, the video encoding logic may be H.264 compliant.

According to some embodiments of the present invention, the VBBPL may further comprise encoded video editing logic adapted to edit encoded video data. According to some embodiments of the present invention, the encoded video data may be received from the VBBPL. According to some embodiments of the present invention, the encoded video data may be received by the DBBPL. According to some embodiments of the present invention, the encoded video editor may be further adapted to receive or generate video control layer data for appending to encoded video data. According to some embodiments of the present invention, the encoded video editor may be further adapted to append or overlay the video control layer data to encoded video data.

According to some embodiments of the present invention, the video circuit may further comprise a buffer adapted to buffer encoded video frame data received by the transmitter as encoded video frames. According to some embodiments of the present invention, the encoded video editor may be further adapted to edit one or more buffered encoded video frames.

According to some embodiments of the present invention, the DBBPL may include Wi-Fi baseband processing functionality. According to some embodiments of the present invention, the video circuit may further comprise a packetizer adapted to packetize encoded video data. According to some embodiments of the present invention, the RF transmission circuit may be further adapted to transmit packetized data.

According to some embodiments of the present invention, the video circuit may include at least partial Secure Digital Input Output (SDIO) connectivity between the VBBPL and the RF transmission circuit. According to some embodiments of the present invention, the video circuit may include at least partial analog connectivity between the VBBPL and the RF transmission circuit. According to some embodiments of the present invention, the video circuit may include hybrid analog-digital connectivity between the VBBPL and the RF transmission circuit.

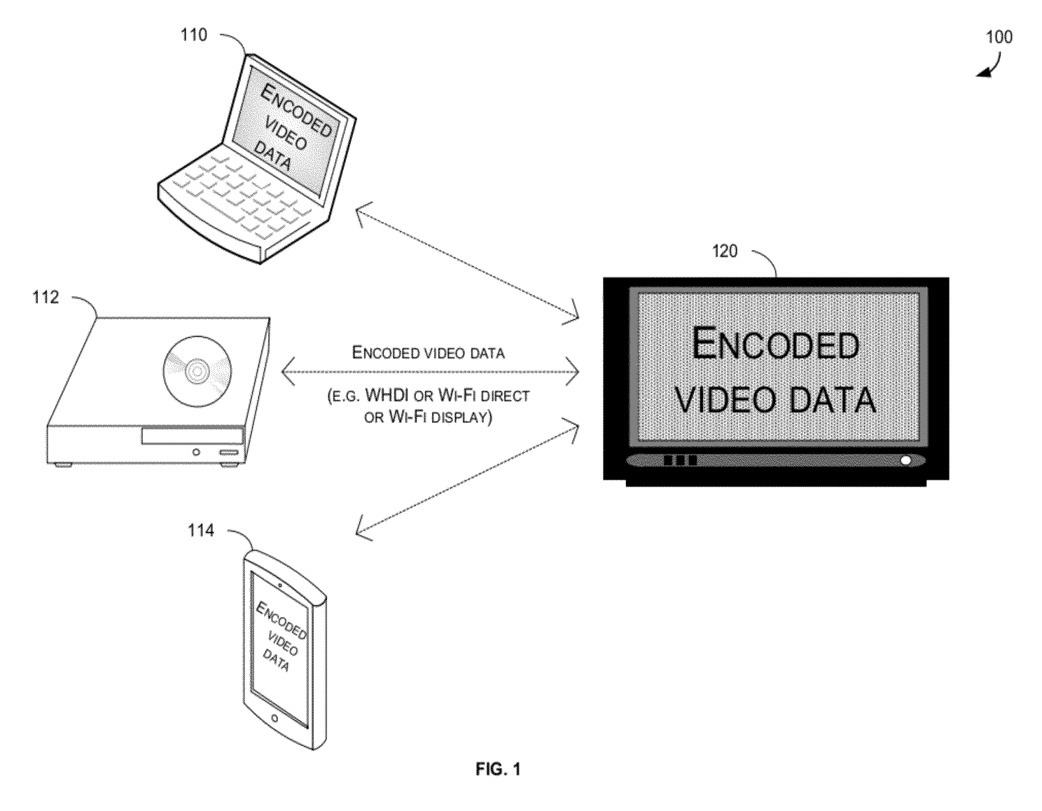

Now turning to FIG. 1, there is shown a diagram illustrating an exemplary arrangement of video transmitting host devices and a video receiving display (100), according to embodiments of the present invention.

According to some embodiments of the present invention, the video transmitting host devices (100, 112 and 114) may transmit encoded video data (e.g. Wireless High Definition Interface—WHDI, Wi-Fi direct or Wi-Fi display data) to an external display (e.g. a monitor, a projector or a television—120) via a wireless transmission link utilizing a radio-frequency (RF) transmitter. The RF transmitter may be a substantially standard WLAN and/or Wi-Fi transmitter.

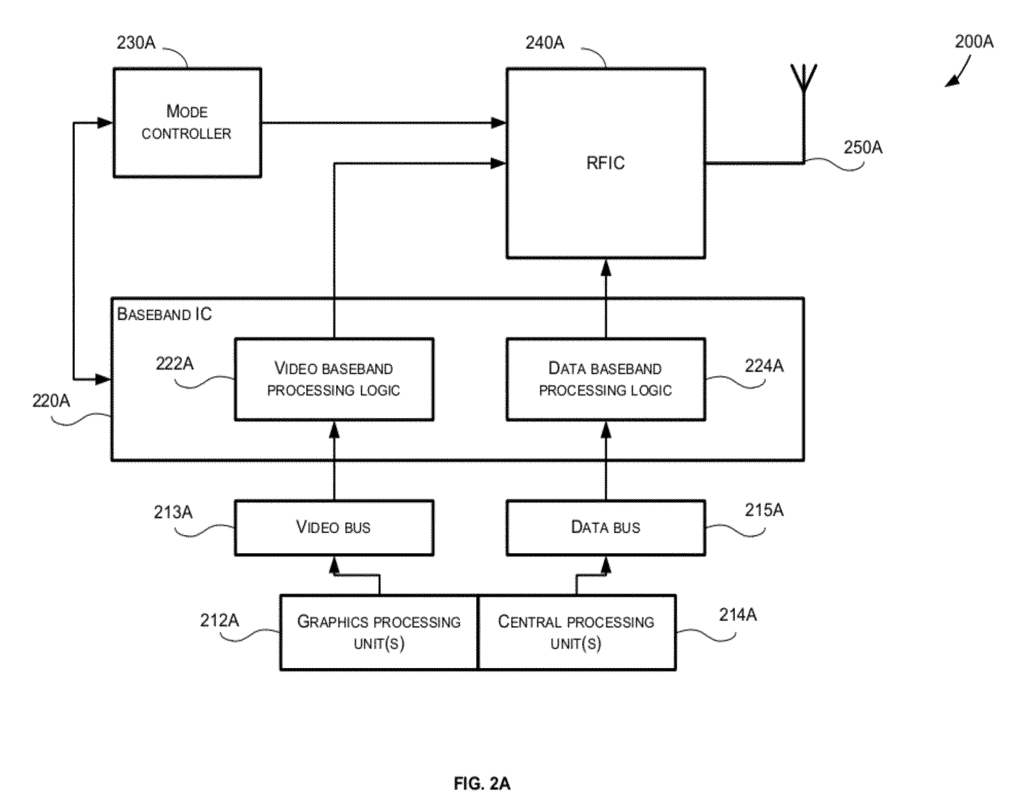

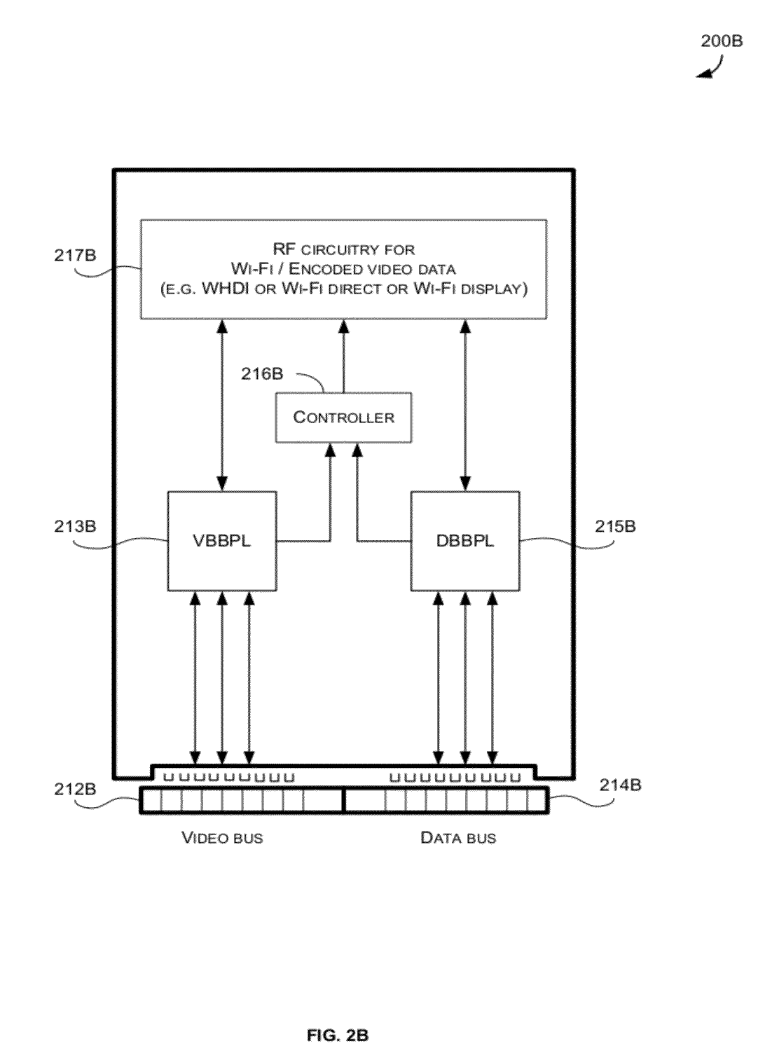

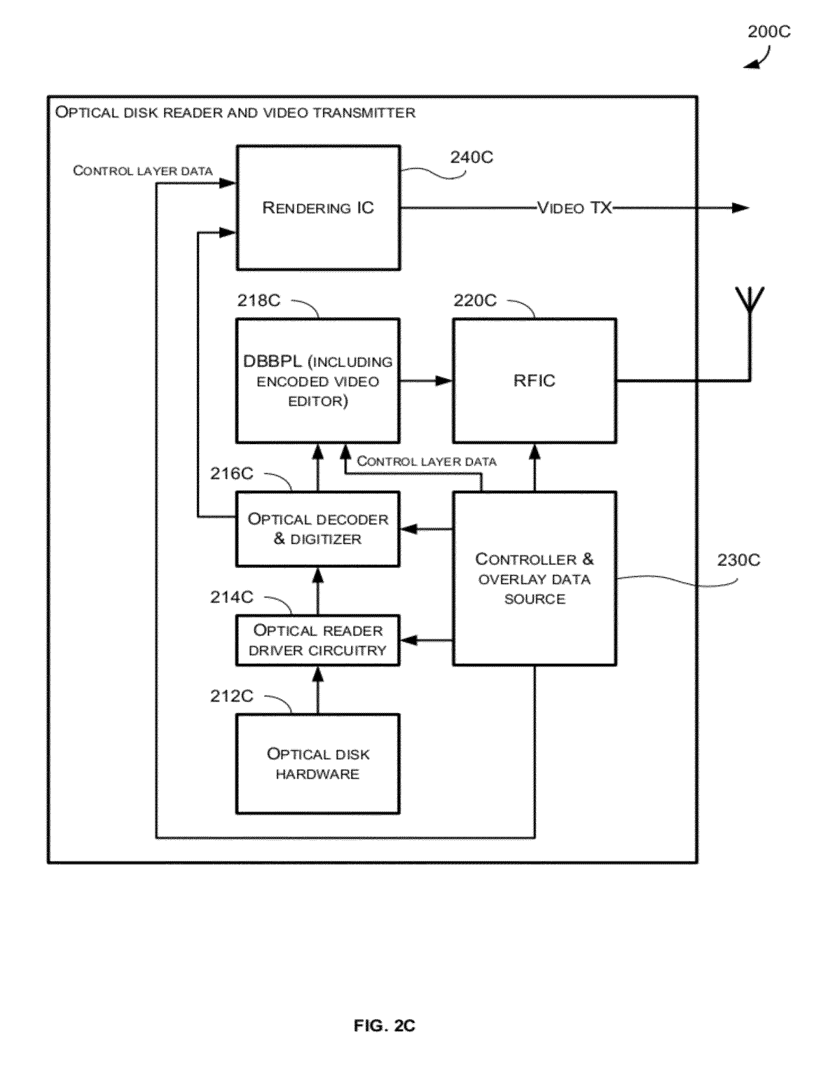

Now turning to FIG. 2A, there is shown a functional block diagram of a video transmitter (200A) according to embodiments of the present invention, where a radio-frequency integrated circuit (RFIC 240A) is shared between a video baseband processing logic (VBBPL 222A) and a data baseband processing logic (DBBPL 224A). In this exemplary embodiment, the VBBPL (222A) and DBBPL (224A) are located on the same baseband IC (220A).

According to some embodiments of the present invention, decoded and/or raw (i.e. substantially uncompressed) video data may be generated and/or routed by one or more graphics processing unit(s) (GPU(s) 212A). The decoded and/or raw video data may be transmitted to functionally associated circuits and/or devices via an integral or otherwise functionally associated video bus (213A). According to further embodiments of the present invention, decoded and/or raw video data selected for wireless transmission may be sent to the VBBPL (222A) for encoding and/or baseband processing.

According to some embodiments of the present invention, network and/or encoded video data may be generated and/or routed by one or more central processing unit(s) (CPU(s) 214A). The network and/or encoded video data may be transmitted to functionally associated circuits and/or devices via an integral or otherwise functionally associated data bus (215A). According to further embodiments of the present invention, network and/or encoded video data selected for wireless transmission may be sent to the DBBPL (224A) for baseband processing.

According to some embodiments of the present invention, the baseband IC (220A) may be functionally associated with a mode controller (230A). The mode controller (230A) may communicate with the baseband IC (220A) and may determine a current and/or an imminent transmission mode. The transmission mode may be based on a presence of specific data determined for wireless transmission. According to further embodiments of the present invention, the shared RFIC (240A) may transmit data received from the baseband IC (220A) based on a control signal from the mode controller (230A).

Now turning to FIG. 2B, there is shown a functional block diagram of a video transmitter card (200B—e.g. a display minicard) according to embodiments of the present invention where radio-frequency (RF) circuitry (217B) is shared between a video baseband processing logic (VBBPL 213B) and a data baseband processing logic (DBBPL 215B).

According to some embodiments of the present invention, decoded and/or raw (i.e. substantially uncompressed) video data may be received via a video bus (212B) while network and/or encoded video data may be received by a data bus (214B). According to further embodiments of the present invention, decoded and/or raw video data selected for wireless transmission may be sent to the VBBPL (213B) for encoding and/or baseband processing. According to further embodiments of the present invention, network and/or encoded video data selected for wireless transmission may be sent to the DBBPL (215B) for baseband processing.

According to some embodiments of the present invention, a controller (216B) may determine a current and/or an imminent transmission mode. The transmission mode may be based on a presence of specific data determined for wireless transmission. According to further embodiments of the present invention, the shared RF circuitry (217B) may transmit data received from the VBBPL (213B) and/or the DBBPL (215B) based on a control signal from the controller (216B).

Now turning to FIG. 2C, there is shown a functional block diagram of an optical disk reader and video transmitter (200C) according to embodiments of the present invention where a DBBPL (218C) may include an encoded video editor for appending control layer data to encoded video data.

According to some embodiments of the present invention, optical disk hardware (212C) may include a holding location for an optical memory storage disk. According to further embodiments of the present invention, optical sensor circuitry (214C) may be adapted for reading data from the optical disk. According to further embodiments of the present invention, an optical decoder & digitizer (216C) may be adapted to convert and/or adapt the data into a digital data signal. The digital data signal may include encoded video data that may be transmitted to functionally associated circuits and/or devices. According to further embodiments of the present invention, encoded video data may be sent to a rendering IC (240C) for video output. Encoded video data selected for wireless transmission may be sent to the DBBPL (218C) for baseband processing. Processed encoded video data may be sent to a radio-frequency integrated circuit (RFIC 220C) for wireless transmission.

According to some embodiments of the present invention, a controller & overlay data source (230C) may control encoded video data flow between the optical sensor circuitry (214C), optical decoder & digitizer (216C), DBBPL (218C), rendering IC (240C) and RFIC (220C). According to further embodiments of the present invention, control layer (video overlay) data may be generated by the controller & overlay data source (230C) based on user and/or system input. According to further embodiments of the present invention, control layer data may be transmitted to the rendering IC (240C) for appending to the outgoing video signal. According to further embodiments of the present invention, control layer data may be transmitted to the DBBPL (218C) for appending to the baseband encoded video via an integral or otherwise functionally associated encoded video editor.

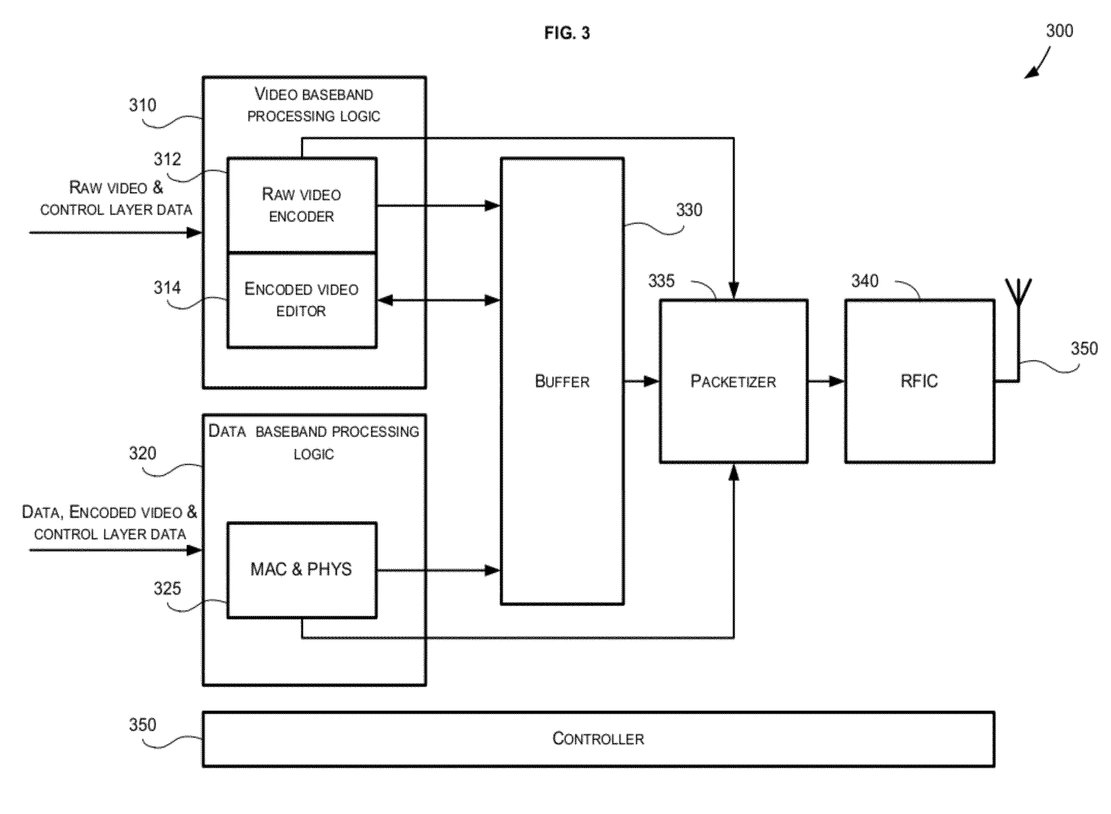

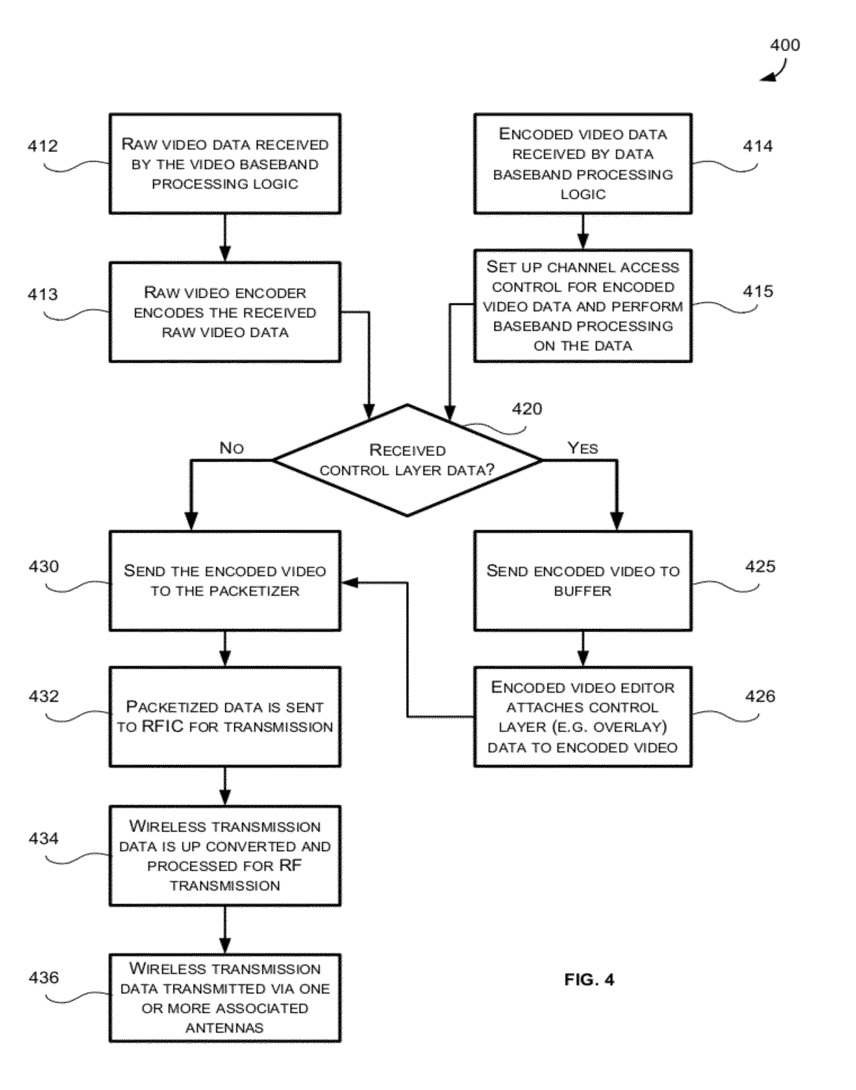

Now turning to FIG. 3, there is shown a functional block diagram of a video transmitter for a host device (300), according to embodiments of the present invention where a VBBPL (310) and DBBPL (320) share a buffer (330) and a packetizer (335) in addition to an RFIC (340). The operation of the video transmitter for a host device (300) may be described in view of FIG. 4, showing a flowchart (400) including the steps of an exemplary method by which the video transmitter of FIG. 3 may operate, in accordance with some embodiments of the present invention.

According to some embodiments of the present invention, raw (i.e. substantially uncompressed) video data may be received (412) by the VBBPL (310). The VBBPL (310) may include a raw video encoder (312) that may encode (413) the received raw video data into encoded video data. Encoding formats may include MPEG-4, MPEG-4 advance video coding (MPEG-4AVC-H.264), or any other suitable video encoding format.

According to some embodiments of the present invention, encoded video data may be received (414) by the DBBPL. The DBBPL (320) may include a MAC & physical layer (PHYS) circuit and/or module (325) that may set up (415) channel access control for encoded video data and perform baseband processing on the data. According to further embodiments of the present invention, encoded video may be sent (430) to the packetizer (335) to prepare the data for transmission.

According to some embodiments of the present invention, receiving control layer data (420) may trigger the video transmitter to send (425) encoded video to the buffer (330). AN encoded video editor (314) integral to or functionally associated with the VBBPL may attach (426) the received control layer (e.g. video overlay) data to the encoded video. According to further embodiments of the present invention, the encoded video including control layer data may be sent (430) to the packetizer (335) to prepare the data for transmission.

According to some embodiments of the present invention, packetized encoded video data may be sent (432) to the RFIC (340) for transmission. According to further embodiments of the present invention, wireless transmission data may be up converted and processed (434) for RF transmission. According to further embodiments of the present invention, wireless transmission data may be transmitted (436) via one or more functionally associated or integral antenna(s) (350).

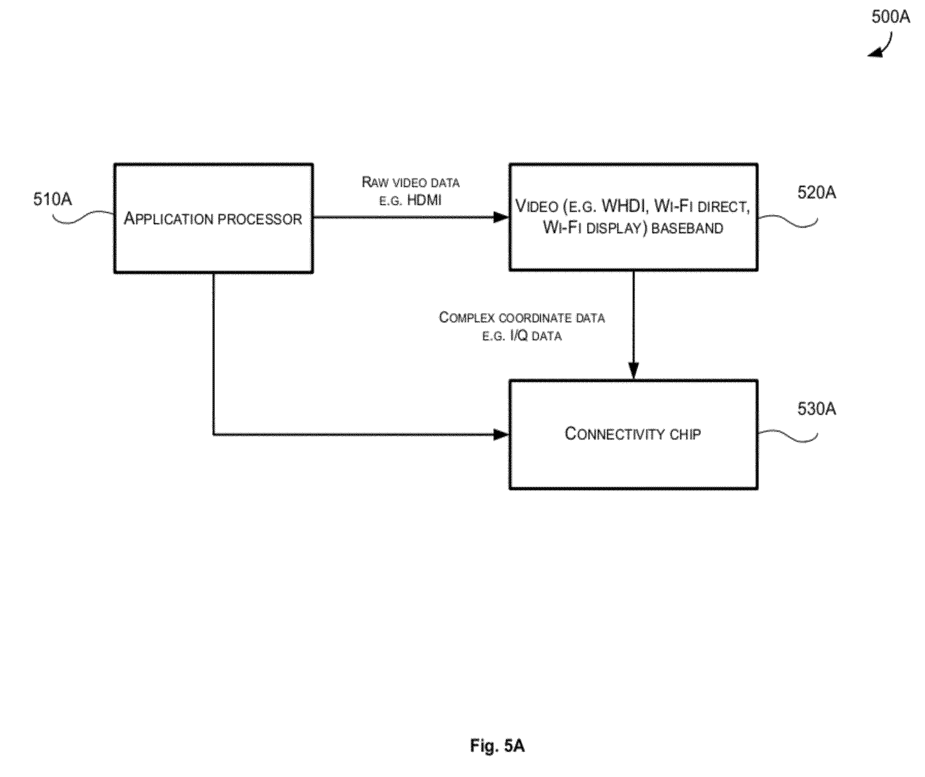

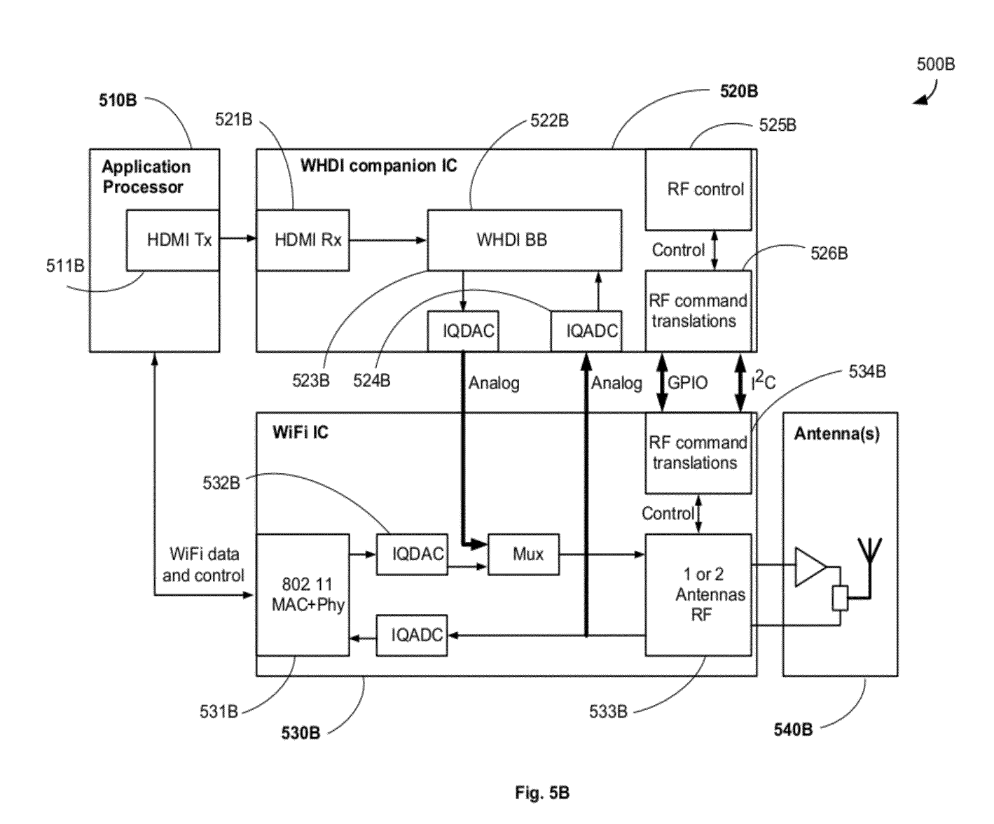

Now turning to FIGS. 5A & 5B, there are shown block diagrams of exemplary configurations for the integration of a video baseband (e.g. Wireless High Definition Interface—WHDI, Wi-Fi direct or Wi-Fi display) IC (520A) into an exemplary computing and/or communications device (500A) as a companion IC, in accordance with some embodiments of the present invention.

According to some embodiments of the present invention, the video baseband companion IC (520A) may be adapted to receive raw (i.e. substantially uncompressed) video e.g. HDMI (High-Definition Multimedia Interface) data from an Application Processor (510A), and transmit complex coordinate data (e.g. I/Q data) to a connectivity chip (e.g. Wi-Fi IC) (530A). According to further embodiments of the present invention, additional network based data and control data may be transmitted directly from the Application Processor (510A) to the connectivity chip (530A).

According to some embodiments of the present invention, application Processor 510B may utilize an HDMI transmitter (511B) to transmit digital data to an HDMI receiver (521B) on a WHDI companion IC (520B). The WHDI IC (520B) may further comprise a WHDI baseband integrated circuit (BBIC) (522B) where received data may be interfaced, modulated and transmitted to an I/Q digital to analog converter (IQDAC 523B) for conversion into an analog signal. The analog signal may be transmitted to the Wi-Fi IC (530B). According to further embodiments, the WHDI IC (520B) may further comprise an I/Q analog to digital converter (IQADC 524B) adapted to receive analog signals from the Wi-Fi IC (530B) and convert them to digital signals to be transferred to the WHDI baseband integrated circuit (BBIC) (522B).

According to some embodiments of the present invention, the WHDI IC (520B) may further include an RF controller (525B) adapted to transmit RF control commands to an RF command translations unit (526B) for translation and transmission to the Wi-Fi IC (530B) through a serial computer bus (e.g. PC (Inter-Integrated Circuit)) and/or another interface connection (e.g. GPIO (General Purpose Input/Output)).

According to some embodiments of the present invention, the Application Processor (510B) may also transmit and receive Wi-Fi data and control directly to/from a MAC (Media Access Control) address circuit (531B) on the Wi-Fi IC (530B). The transmitted Wi-Fi data and control may be converted to an analog signal by an IQDAC (532B) on the Wi-Fi IC (530B) and the resulting analog signal(s) multiplexed with another/other analog signal(s) received from the WHDI IC's (520B) IQDAC (523B). Joined multiplexed signal may be transmitted to an Antenna RF Circuit (533B) that may be further adapted to receive RF control commands from the WHDI IC's (520B) RF command translations unit (526B) through a serial computer bus (e.g. I²C (Inter-Integrated Circuit)) and/or another interface connection (e.g. GPIO (General Purpose Input/Output)) and further through a RF command translations unit (534B) on the Wi-Fi IC (530B) to said Antenna(s) RF Circuit (533B). Signals from the Antenna RF Circuit (533B) may be transmitted to one or more antenna(s) (540B) for wireless transmission.

According to some embodiments of the present invention, signal(s) received by the antenna (540B) may be transmitted to the Antenna(s) RF Circuit (533B) and then demultiplexed into two or more signals that may travel to the Application Processor (510B) either through the WHDI IC's (520B) or directly from the Wi-Fi IC's (530B) MAC (Media Access Control) address circuit (531B).

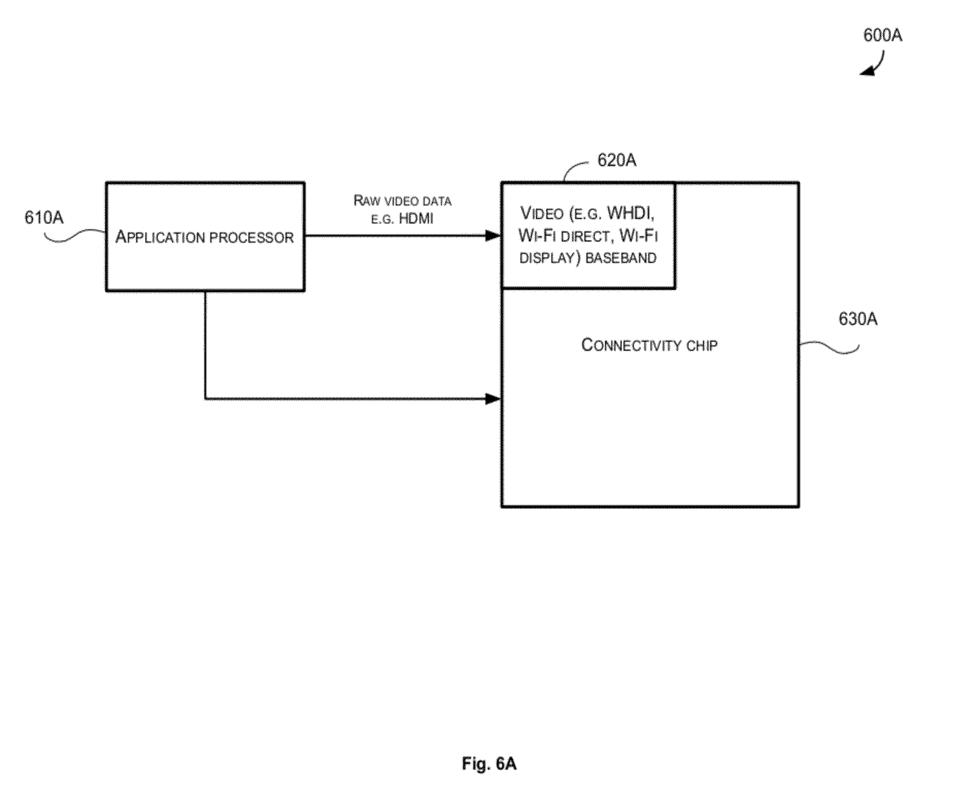

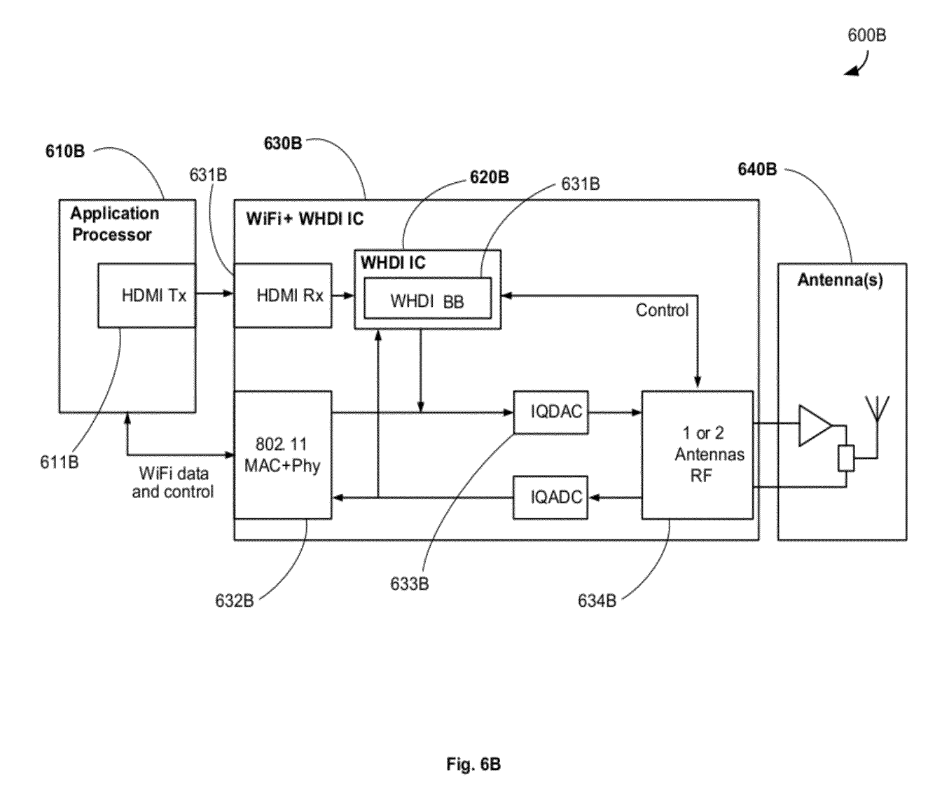

Now turning to FIGS. 6A & 6B, there are shown block diagrams of exemplary configurations for the integration of a video baseband (e.g. Wireless High Definition Interface—WHDI, Wi-Fi direct or Wi-Fi display) IC (620A) into a connectivity chip (e.g. Wi-Fi IC) (630A) of an exemplary computing and/or communications device (600A), in accordance with some embodiments of the present invention.

According to some embodiments of the present invention, the video baseband IC (620A) may be adapted to receive raw (i.e. substantially uncompressed) video e.g. HDMI (High-Definition Multimedia Interface) data from an Application Processor (610A). According to further embodiments of the present invention, additional network based data and control data may be transmitted directly from the Application Processor (610A) to the connectivity chip (630A).

According to some embodiments of the present invention, application Processor 610B may utilize an HDMI transmitter (611B) to transmit digital data to an HDMI receiver (631B) on the Wi-Fi IC (630B). The WHDI IC (620B) may comprise a WHDI baseband integrated circuit (BBIC) (621B) where received data may be interfaced, modulated and transferred, along with additional Wi-Fi data and control from the MAC (Media Access Control) address circuit (632B), to an IQDAC (633B) for conversion into an analog signal. The analog signal may be transmitted to an antenna(s) RF Circuit (634B).

According to some embodiments of the present invention, the RF Circuit (634B) may be further adapted to receive RF control commands from the WHDI IC (620B). Signals from the Antenna(s) RF Circuit (634B) may be transmitted to an antenna (640B) for wireless transmission.

According to some embodiments of the present invention, signal(s) received by the antenna (640B) may be transmitted to the Antenna(s) RF Circuit (634B) and then to a IQADC (633B) for conversion into a digital signal that may be transmitted to the MAC (Media Access Control) address circuit (632B) and possibly to the Application Processor (610A), and/or to the WHDI IC (620B).

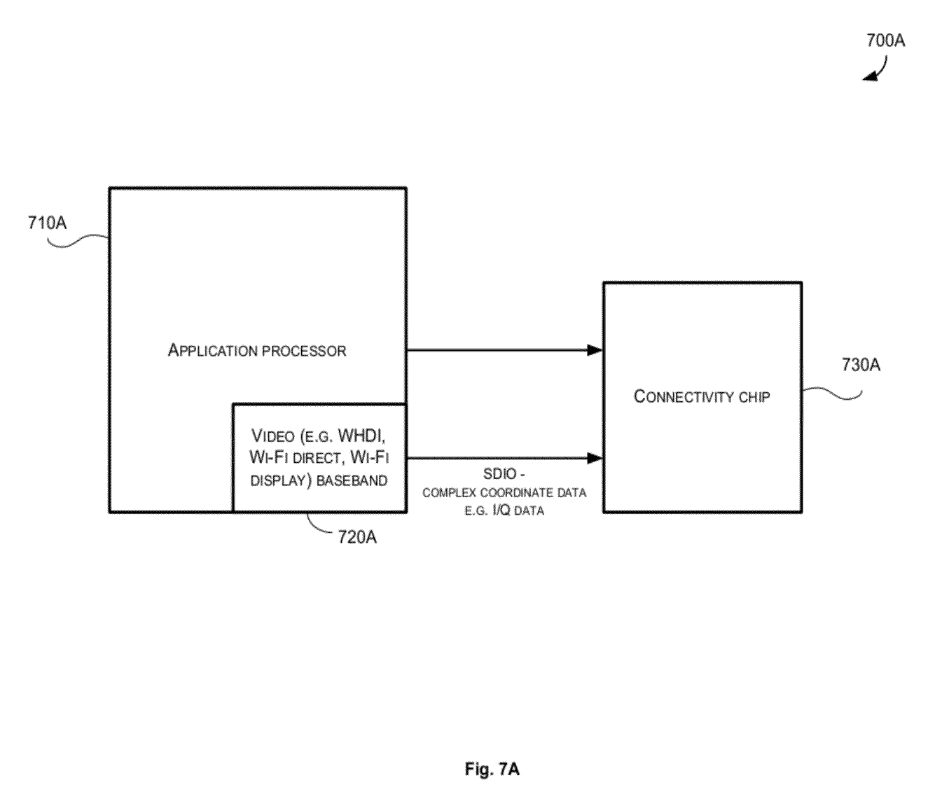

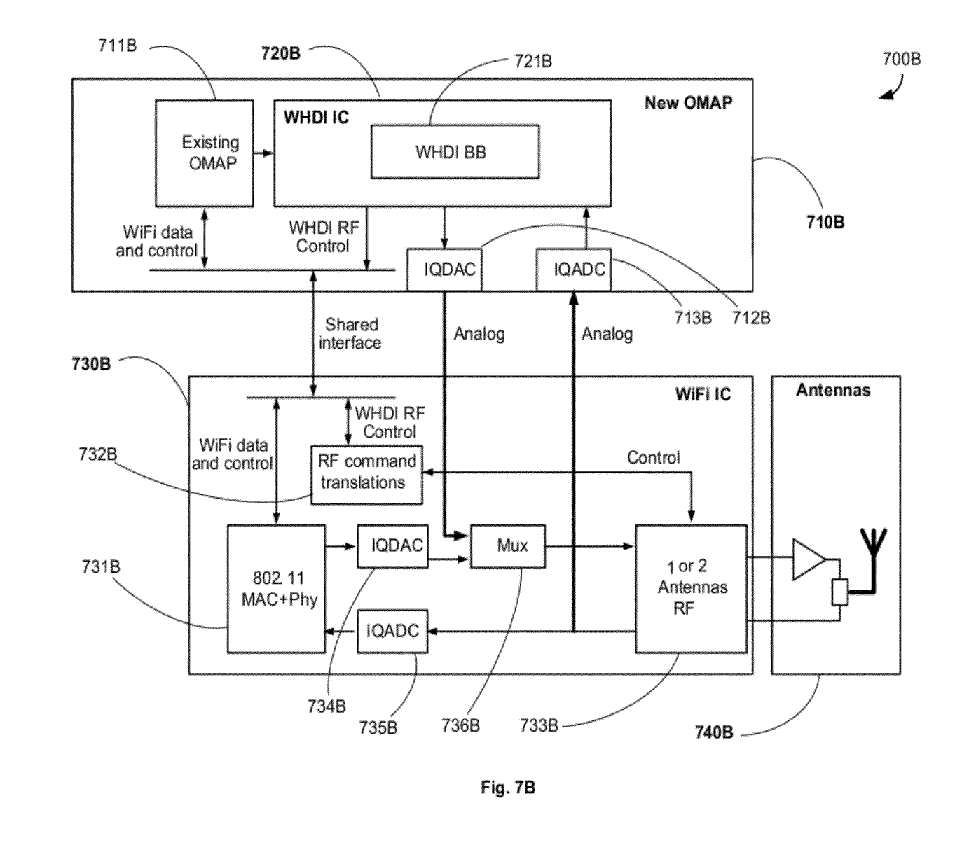

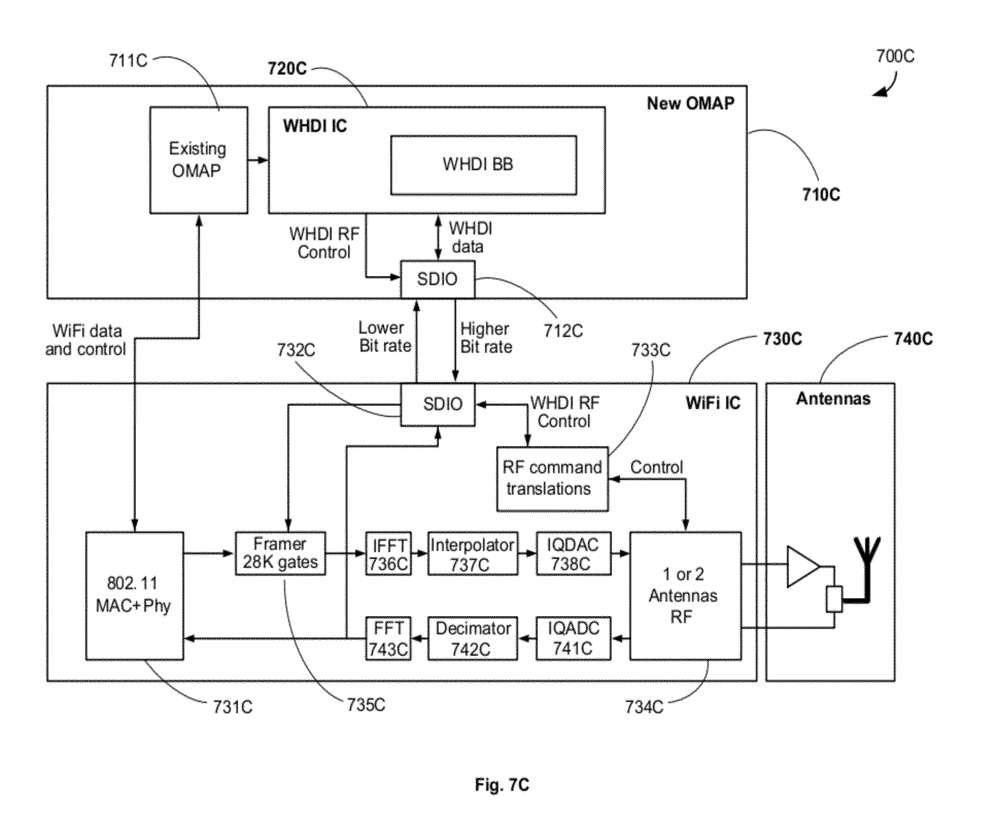

Now turning to FIGS. 7A-7C, there are shown block diagrams of exemplary configurations for the integration of a video baseband (e.g. Wireless High Definition Interface—WHDI, Wi-Fi direct or Wi-Fi display) IC into an Application Processor of an exemplary computing and/or communications device, in accordance with some embodiments of the present invention.

According to some embodiments of the present invention, a video baseband (e.g. Wireless High Definition Interface—WHDI, Wi-Fi direct or Wi-Fi display) IC (720A) may be integrated into an application processor (710A) of an exemplary computing and/or communications device (700A). Complex coordinate data (e.g. I/Q Data) from the application processor (710A) and video baseband IC (720A) may be transmitted through an SDIO (Secure Digital Input Output) interface to connectivity (e.g. Wi-Fi) IC 730A of the computing and/or communications device (700A).

According to some embodiments of the present invention, an existing application processor (711B) (e.g. an OMAP (Open Multimedia Applications Platform)) may be integrated, along with a WHDI IC (720B), into a new application processor (710B) (e.g. into an additional OMAP).

According to some embodiments of the present invention, the existing application processor (711B) and the WHDI IC (720B) may share an interface for transmitting Wi-Fi data and control, and WHDI RF Control, respectively; to/from the Wi-Fi IC (730B). Wi-Fi data and control may be transmitted through the shared Interface to/from the Wi-Fi IC's (730B) MAC (Media Access Control) circuit (731B). WHDI RF Control signals may be transmitted through the shared interface to/from the Wi-Fi IC's (730B) RF command translation unit (732B) and to/from an Antenna(s) RF Circuit (733B).

According to some embodiments of the present invention, application processor 710B may further comprise an IQDAC (712B) adapted to convert signals, coming from the WHDI IC (720B), from digital to analog prior to their transmission to the Wi-Fi IC (730B). Application processor 710B may include an IQADC (713B) adapted to convert signals, received from the Wi-Fi IC (730B) and travelling towards the WHDI IC (720B), from analog to digital.

According to some embodiments of the present invention, the Wi-Fi IC (730B) may comprise an IQDAC (734B) adapted to convert signals coming from the MAC (Media Access Control) circuit (731B) and an IQADC (735B) adapted to convert signals coming from the Antenna RF Circuit (733B) the travelling towards the MAC (Media Access Control) address circuit (731B). According to some embodiments, a multiplexer (736B) may be used to multiplex converted signal(s) (now analog) from the MAC (Media Access Control) circuit (731B) and analog signal(s) from the Application Processor's (710B) IQDAC (712B). The joined multiplexed signal may be transferred to the Antenna(s) RF Circuit (733B). Signals from the Antenna(s) RF Circuit (733B) may be transferred to one or more antennas (740B) for transmission.

According to some embodiments of the present invention, signal(s) received by the antenna(s) (740B) may be transferred to the Antenna(s) RF Circuit (733B) and then demultiplexed into two or more signals at least part of which may travel to the WHDI IC (720B) through the Application Processor's (710B) IQADC (713B) and at least another part of which (e.g. Wi-Fi data and control return signals) may be converted to digital signal(s) by the IQADC (735B) transferred to the MAC (Media Access Control) circuit (731B) and from there transmitted to the Application Processor's (710B) existing Application Processor (711B) through the aforementioned shared interface.

According to some embodiments of the present invention, an existing Application Processor (711C) (e.g. an OMAP (Open Multimedia Applications Platform)) may be integrated, along with a WHDI IC (720C), into the Application Processor (710C) (e.g. an additional OMAP).

According to some embodiments of the present invention, the existing Application Processor (711C) may transmit Wi-Fi data and control signals to/from the Wi-Fi IC's (730A) MAC (Media Access Control) circuit (731C). The WHDI IC (720C) may transmit WHDI RF Control and WHDI data to the Wi-Fi IC (730C) through an SDIO (Secure Digital Input Output) connection (712C and 732C). According to some embodiments, the SDIO (Secure Digital Input Output) connection (712C and 732C) may be adapted to allow different up-link and down-link bitrates (e.g. In mbps up-link rate and lower mbps down-link rate).

According to some embodiments of the present invention, up-link signals arriving at the SDIO (Secure Digital Input Output) connection (732C) Wi-Fi IC (730C) side may include WHDI RF Control signals that may be transmitted to a RF command translation unit (733C) and further transmitted to an Antenna(s) RF Circuit (734C). According to some embodiments, WHDI RF Control signals may travel from the Antenna(s) RF Circuit (734C) through the RF command translation unit (733C) to the SDIO (Secure Digital Input Output) connection (732C) and back to the Application Processor (710C) through the SDIO (Secure Digital Input Output) connection (712C) Application Processor (710C) side.

According to further embodiments, up-link signals arriving at the SDIO (Secure Digital Input Output) connection (732C) Wi-Fi IC (730C) side may further include additional signals. A framer (735C) may break these signals and possibly other signals arriving from the MAC (Media Access Control) circuit (731C) into frames. An Inverse Fast Fourier Transform (736C), an interpolation or other form of curve fitting may then be performed on the data frames by an interpolator (737C). Interpolated data may then be converted to an analog signal by an IQDAC (738C) before being transmitted to the Antenna(s) RF Circuit (734C). Signals from the Antenna(s) RF Circuit (734C) may be transferred to one or more antennas (740C) for transmission.

According to some embodiments of the present invention, signal(s) received by the antenna(s) (740C) may be transferred to the Antenna(s) RF Circuit (734C), and may be converted to a digital form by the IQADC (741C). According to further embodiments of the present invention, the number of samples contained in the signals may be reduced by a decimator (742C) and a Fast Fourier Transform (743C) may be performed on them. Processed signals may then be transferred to the MAC (Media Access Control) circuit (731C) through the SDIO (Secure Digital Input Output) connection (732C) and through the SDIO (Secure Digital Input Output) connection (712C) on to the Application Processor's (710C) WHDI IC (720C).

Some embodiments of the invention, for example, may take the form of an entirely hardware embodiment, an entirely software embodiment, or an embodiment including both hardware and software elements. Some embodiments may be implemented in software, which includes but is not limited to firmware, resident software, microcode, or the like.

Furthermore, some embodiments of the invention may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

In some embodiments, the medium may be an electronic, magnetic, optical, electromagnetic, infrared, or semiconductor system (or apparatus or device) or a propagation medium. Some demonstrative examples of a computer-readable medium may include a semiconductor or solid state memory, magnetic tape, a removable computer diskette, a random access memory (RAM), a read-only memory (ROM), a rigid magnetic disk, and an optical disk. Some demonstrative examples of optical disks include compact disk—read only memory (CD-ROM), compact disk—read/write (CD-R/W), and DVD.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components may be used.

Functions, operations, components and/or features described herein with reference to one or more embodiments, may be combined with, or may be utilized in combination with, one or more other functions, operations, components and/or features described herein with reference to one or more other embodiments, or vice versa.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A video circuit comprising:
video baseband processing logic (VBBPL) adapted to manage video specific wireless communication sessions;
data baseband processing logic (DBBPL) adapted to manage data specific wireless communication sessions; and
a radio-frequency (RF) transmission chain (TX) functionally associated with said VBBPL and with said DBBPL, and adapted to generate wireless transmission signals corresponding to outputs of said VBBPL and said DBBPL, wherein the outputs of the VBBPL and the DBBPL are interleaved.

2. The video circuit according to claim 1, wherein said VBBPL further comprises a video encoding logic to encode raw video data.

3. The video circuit according to claim 2, wherein said video encoding logic is Wireless High Definition Interface (WHDI) compliant.

4. The video circuit according to claim 2, wherein said video encoding logic is H.264 compliant.

5. The video circuit according to claim 2, wherein said VBBPL further comprises encoded video editing logic adapted to edit encoded video data.

6. The video circuit according to claim 5, wherein the encoded video data is received from said VBBPL.

7. The video circuit according to claim 5, wherein the encoded video data is received by said DBBPL.

8. The video circuit according to claim 5, wherein said encoded video editor is further adapted to receive or generate video control layer data for appending to encoded video data.

9. The video circuit according to claim 8, wherein said encoded video editor is further adapted to append or overlay the video control layer data to encoded video data.

10. The video circuit according to claim 5, further comprising a buffer adapted to buffer encoded video frame data received by the transmitter as encoded video frames.

11. The video circuit according to claim 10, wherein said encoded video editor is further adapted to edit one or more buffered encoded video frames.

12. The video circuit according to claim 1, wherein said DBBPL includes Wi-Fi baseband processing functionality.

13. The video circuit according to claim 1, further comprising a packetizer adapted to packetize encoded video data.

14. The video circuit according to claim 13, wherein said RF transmission circuit is further adapted to transmit packetized data.

15. The video circuit according to claim 1 including at least partial Secure Digital Input Output (SDIO) connectivity between said VBBPL and said RF transmission circuit.

16. The video circuit according to claim 1 including at least partial analog connectivity between said VBBPL and said RF transmission circuit.

17. The video circuit according to claim 16 including hybrid analog-digital connectivity between said VBBPL and said RF transmission circuit.
